(19) United States
(12) Patent Application Publication
(10) Pub. No.: US 2012/0167780 A1
(43) Pub. Date: Jul. 5, 2012

(54) INSERTABLE COOKING ENCLOSURE

(76) Inventor: Kent Maxwell Houston, Loveland, CO (US)

(21) Appl. No.: 12/983,883

(22) Filed: Jan. 3, 2011

(51) Int. Cl. A47J 37/00

(52) U.S. Cl. 99/447

(57) ABSTRACT

Embodiments of an insertable cooking enclosure disclosed herein include a top portion, one or more side portions, and one or more flame-retarding baffle structures integrated into the cooking enclosure. Embodiments herein may be inserted into or placed onto a heat source such as a barbecue grill, an oven, and/or a stove top to convect heated air and accumulate the heated air in a baking chamber bounded by the insertable cooking enclosure. The baffle structures retard flames and hotspots to avoid excessive temperatures within the baking chamber and to promote even cooking.

### TECHNICAL FIELD

Embodiments described herein relate to apparatus associated with cooking and baking, including structures and techniques related to concentrating heated air in an area surrounding food to be cooked.

### BACKGROUND INFORMATION

In the food preparation arts, it is well known that certain foods benefit from being cooked at the upper end of a range of possible temperatures. Taste, moisture content, texture, and color are among variables that may be influenced by selecting appropriately high cooking temperatures. Higher cooking/baking temperatures cause caramelization of sugars in some foods, resulting in pleasing colors and taste. For example, steaks braised at higher temperatures may form a subtle crust at the outer surfaces. The crust serves as a barrier to contain moisture, resulting in a juicier cooked product. Commercial pizza ovens typically operate at approximately 750° Fahrenheit (400° Celsius) and may bake a pizza in three minutes or less. That baking technique may result in a pleasantly crispy crust; and topping flavors may be enhanced by avoiding long cooking times.

A potential problem associated with cooking at higher temperatures is the risk of burning the food while cooking. That risk increases in the case of cooking devices whose heat source is associated with flames or heating elements proximate to the food to be cooked. Commercial cooking systems may be designed to provide uniformity of cooking temperature around the food to avoid “hot spots” that could result in an unevenly cooked product. Such commercial equipment may be bulky, require considerable power/fuel and may be expensive to produce, thus rendering it impractical for acquisition by the average home user.

An additional factor that may complicate a home user's implementation of high-temperature cooking with evenly-heated air is the decision of where to cook. Current-day households may sometimes cook indoors in an oven or on a stove and may cook on an outdoor cooker such as a barbecue grill or smoker at other times. Residential ovens and outdoor grills typically do not reach the higher temperatures and evenly-heated air required to produce excellent quality pizza and/or bread, for example.

### BRIEF DESCRIPTION OF THE DRAWINGS

FIG. 1 is a perspective view of the underside of an insertable cooking enclosure according to various example embodiments of the current invention.

FIG. 2 is a perspective view of the underside of an insertable cooking enclosure depicting a baking chamber according to various example embodiments.

FIG. 3 is a top view of a baking plate according to various example embodiments.

FIG. 4 is an upper-front perspective view of an insertable cooking enclosure according to various example embodiments.

FIG. 5 is an upper-front perspective view of an insertable cooking enclosure depicting a flame-retarding insert according to various example embodiments.

### SUMMARY OF THE INVENTION

Embodiments of an insertable cooking enclosure described herein accumulate, concentrate, and disperse heated air from an existing heat source (e.g., oven, stove, or grill) to food enclosed by the cooking enclosure. One or more heat-channeling baffle structures channel the heated air from the heat source upward and around the inner perimeter of the cooking enclosure and into an inner baking chamber. The baffle structures also separate flames and/or hot spots associated with the existing heat source from the baking chamber in order to protect the food from destructive temperatures. Embodiments herein provide a portable, high-temperature cooking environment with evenly-distributed heated air, and require no energy expenditure other than that of the existing heat source.

### DETAILED DESCRIPTION

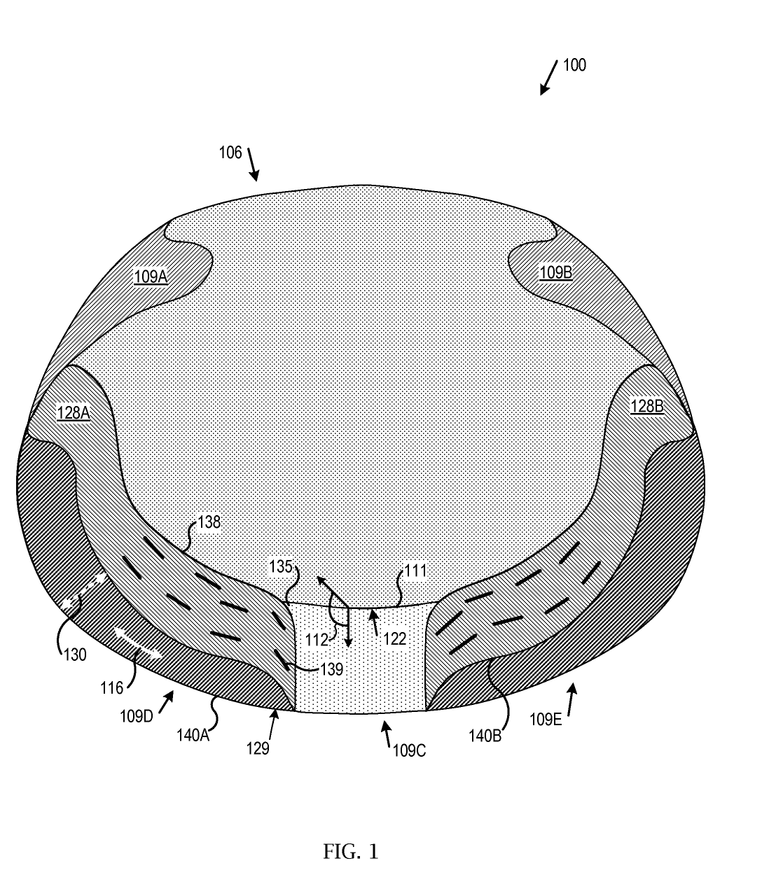

FIG. 1 is a perspective view of the underside of an insertable cooking enclosure 100 according to various example embodiments of the current invention. The cooking enclosure 100 convects and accumulates heated air from a heat source (e.g., an outdoor grill, an oven, or a stove) to a baking chamber within the cooking enclosure and protects food in the baking chamber from excessively high temperatures associated with flames and/or hot spots.

The cooking enclosure 100 includes a top portion 106. The top portion 106 is oriented above and substantially parallel to a cooking surface (e.g., a baking plate) when the cooking enclosure 100 is located on or at the cooking surface during cooking.

A “cooking surface” may include a baking plate, a grill (whether of the open-slotted barbecue type or the flat sheeted type) or other cooking surface. In some embodiments, a cooking surface in the form of a baking plate may be placed on a barbecue grill or other heat source.

In some embodiments, the top portion 106 is substantially circular, as shown in FIG. 1. Alternatively, the top portion 106 may be oval-shaped or shaped as a polygon such as a triangle, a rectangle, a hexagon, etc. The top portion 106 may be substantially flat or may be constructed as a three-dimensional object. In the latter case, the top portion 106 may be dome-shaped, concave-shaped, and/or constructed as a shallow polyhedron. The upper surface of the top portion 106 may be capable of receiving food for pre-baking, post-baking, and/or warming.

The cooking enclosure 100 may also include one or more side portions (e.g., the side portions 109A, 109B, 109C, 109D, and/or 109E, hereinafter referred to as “side portion(s) 109”) coupled to the top portion 106. The side portions 109 are formed along a periphery 111 of the top portion 106 and extend in a substantially orthogonal direction 112 downward from the top portion to form a lateral periphery 116 of the cooking enclosure 100.

The side portions 109 may be formed and/or molded into a substantially cylindrical shape with an end circumference 122 abutted to the periphery 111 of the top portion 106, in the case of embodiments employing a substantially circular top portion. Likewise, the side portions 109 may be formed and/or molded into shapes appropriate to embodiments with non-circular top portions. In some embodiments, the top portion 106 and the side portions 109 may be formed into a substantially continuous structure via processes such as molding, stamping, etc.

The cooking enclosure 100 also includes one or more lateral baffle structures (e.g., the baffle structures 128A and 128B). The baffle structures 128A, 128B are affixed to the top portion 106, the side portions 109, or both. The baffle structures 128A, 128B run along and are spaced away from an inner surface 129 of the side portions 109 by a space of variable width 130. In some embodiments, the baffle structures 128A, 128B are also spaced downward and away from the top portion 106. The resulting space 135 permits a flow of heated air across the top 138 of the baffle structures 128A, 128B and downward into a baking chamber.

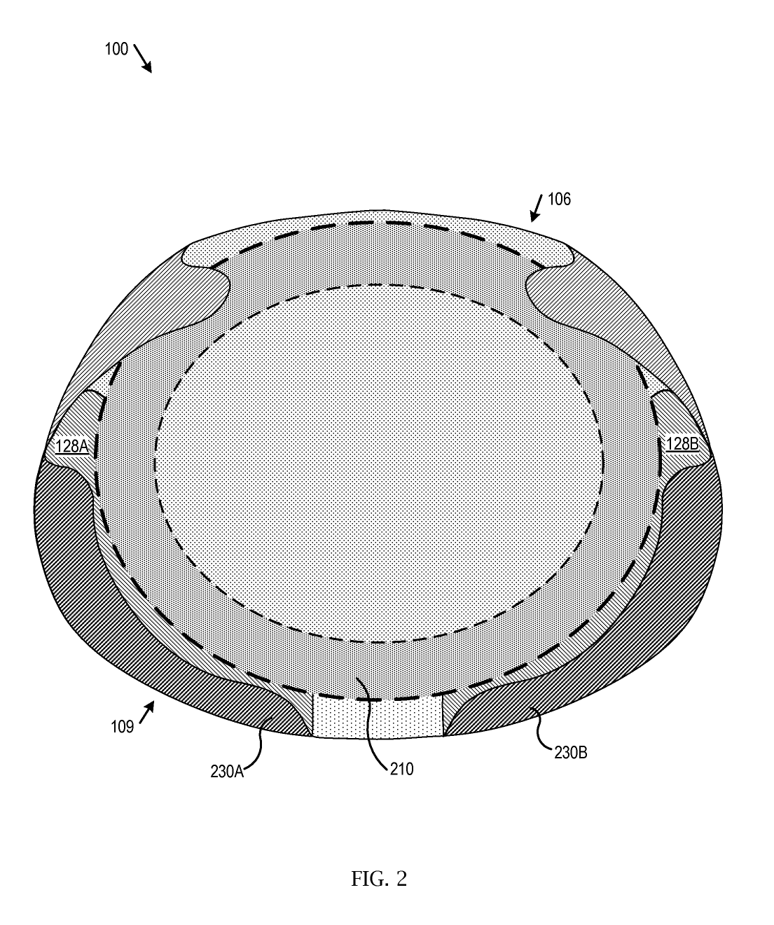

FIG. 2 is a perspective view of the underside of the insertable cooking enclosure 100, depicting a baking chamber 210 according to various example embodiments. It is noted that the baking chamber 210 is not a physical structure, but rather a depiction (using dashed lines) of the space bounded by the top portion 106, the lateral baffle structures 128A, 128B, and a cooking surface (the latter not shown in FIG. 2). Heated air flows from the heat source upward through spaces 230A and 230B between inside surfaces of the side portions 109 and the baffle structures 128A, 128B. In some embodiments, the heated air flows across the top of the baffle structures 128A, 128B and downward into the baking chamber 210.

Some embodiments may be configured with one or more openings in the lateral baffle structures 128A, 128B to provide a flow of hot air across the food in the baking chamber 210. Such openings may include holes of any shape or orientation, including slots (e.g., the example slot 139 of FIG. 1). The quantity, shape and/or spacing of openings in the baffle structures 128A, 128B may be selected by one skilled in the art to provide appropriate airflow over and/or around the food to be cooked. Various embodiments may thus provide for heated airflow into the baking chamber 210 via the space 135 over the baffle structures 128A, 128B, via openings in the baffle structures 128A, 128B, or both.

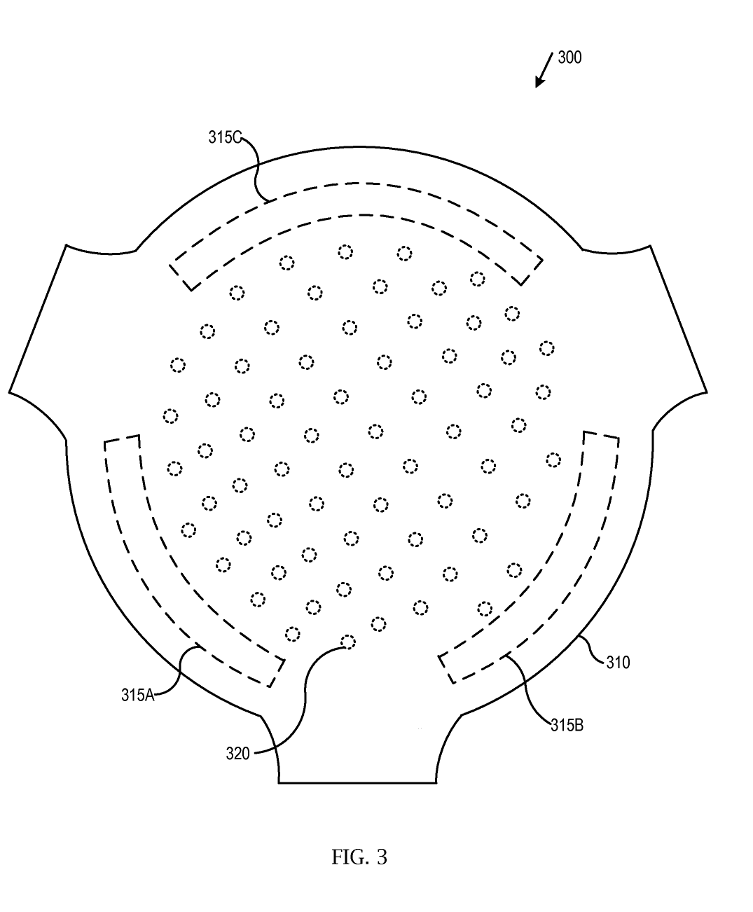

FIG. 3 is a top view of a baking plate 300 according to various example embodiments. In some embodiments, the baffle structures 128A, 128B of FIG. 1 may be shaped to conform and substantially abut to a perimeter 310 of a cooking surface such as the baking plate 300 while the cooking enclosure 100 is in place at the heat source.

Some embodiments may be configured with one or more openings (e.g., the example openings 315A, 315B, and 315C) in the cooking surface. The openings 315A, 315B, 315C provide a flow of hot air into the spaces 230A, 230B of FIG. 2 and/or directly into the baking chamber 210. In some embodiments, small openings (e.g., the example opening 320) may be scattered across the baking plate 300 to provide a controlled amount of hot air to a bottom crust of the food to be cooked. The quantity, shape, orientation, and/or spacing of openings in the cooking surface may be selected by one skilled in the art to provide appropriate airflow over, under, and/or around the food to be cooked.

The top portion 106, the side portions 109, the baffle structures 128A, 128B, and/or the baking plate 300 may be formed from suitable high-temperature materials including ceramics, metals such as stainless steel, thermal plastics, carbon structures such as carbon fibers and/or carbon nanostructures, among others. In some embodiments, the baking plate 300 may be coupled to or insertable into the side portions 109 and/or to the baffle structures 128A, 128B as an integral component of the cooking enclosure 100.

The baffle structures 128A, 128B, in conjunction with the baking plate 300, retard flames and/or hot spots associated with the heat source while allowing high-temperature air to flow up through the spaces 230A, 230B and into the baking chamber 210. Lower portions of the spaces 230A, 230B are accessible to flames and hot spots; however the baffle structures 128A, 128B prevent the flames from reaching food in the baking chamber 210. These structures may isolate food situated in the baking chamber 210 from extreme temperatures while the cooking enclosure 100 is located in place over a cooking surface (e.g., over the baking plate 300 of FIG. 3).

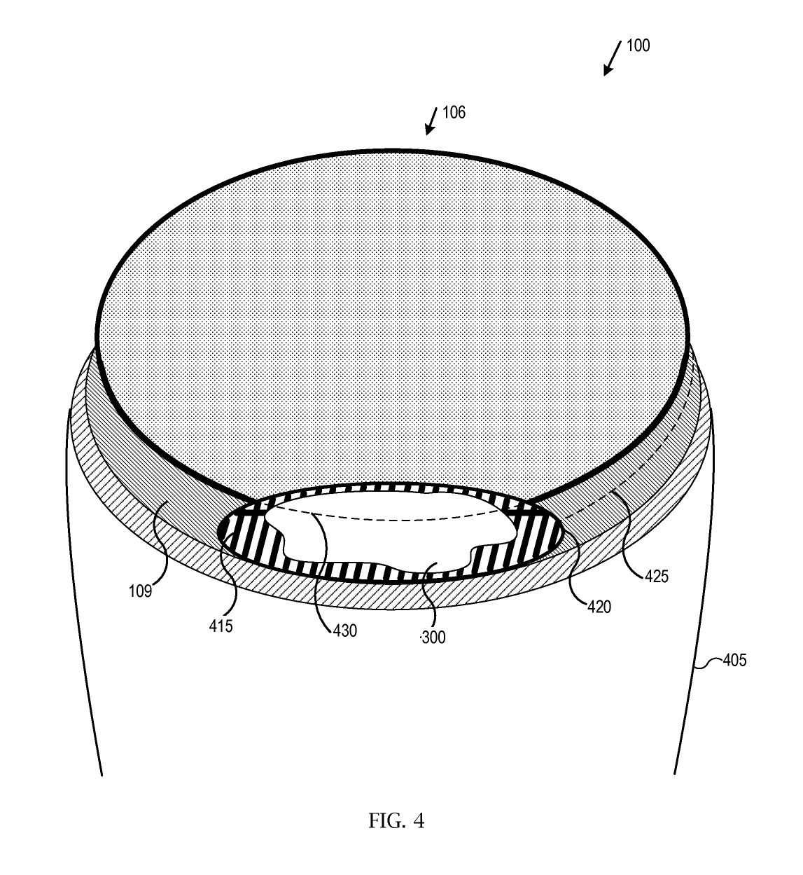

FIG. 4 is an upper-front perspective view of an insertable cooking enclosure 100 according to various example embodiments. The cooking enclosure 100 may be configured to fit into and/or onto an oven, a stove top, and/or an outdoor grill. For example, FIG. 4 depicts the cooking enclosure 100 as it may appear when inserted into a round-shaped outdoor grill 405. Embodiments of the insertable cooking enclosure 100 may include elements and components of shapes and sizes appropriate to the environment in which such embodiments are to be used. (E.g., an embodiment of the cooking enclosure 100 for use with a rectangular-shaped outdoor grill may itself have a rectangular-shaped top portion 106 and four side portions 109.)

Turning back to FIG. 1, footing edges 140A and 140B are associated with the side portions 109 and the lateral baffle structures 128A, 128B, respectively. In some embodiments, the footing edges 140B may be configured to conform to a perimeter 210 of the baking plate 300 of FIG. 3. In the latter case, the footing edges 140A, 140B may rest on a surface that is substantially co-planar with a bottom surface of the baking plate 300. In some embodiments, for example, the footing edges 140A and/or 140B may rest on a grilling surface such as the grilling surface 415 of FIG. 4 when the cooking enclosure 100 is situated in place for cooking. In these embodiments, heated air flows up through the grilling surface 415, into the spaces 230A, 230B of FIG. 2, over the top 138 of the baffle structures 128A, 128B, and into the baking chamber 210.

Alternatively, the footing edges 140A and/or 140B may be configured to rest on the baking plate 300. In some embodiments of these configurations, the baking plate 300 may have openings 315A, 315B, and 315C as previously described in reference to FIG. 3. The openings 315A, 315B, and 315C may allow heated air from the heat source to pass through the baking plate 300, into the spaces 230A, 230B of FIG. 2, over the top 138 of the baffle structures 128A, 128B, and into the baking chamber 210.

In some embodiments, the openings 315A, 315B, 315C, and/or 320 may be located such as to allow heated air to flow directly into the baking chamber 210. For example, the small openings 320 may be scattered across the baking plate 300 to provide a controlled amount of hot air to a bottom crust of the food to be cooked.

The current disclosure also contemplates embodiments of the cooking surface (e.g., the baking plate 300) having openings on both sides of the baffle structures 128A, 128B with the cooking enclosure 100 in place over the cooking surface. Such embodiments provide for simultaneous controlled flows of heated air to pass through the baking plate 300 directly into the baking chamber 210 and through the spaces 230A, 230B, up and over the top 138 of the baffle structures 128A, 128B, and into the baking chamber 210.

The top portion 106 and/or the side portion(s) 109 of the cooking enclosure 100 of FIG. 4 are configured to form a food port opening 420. The food port opening 420 may be formed along a lateral periphery 425 of the cooking enclosure 100, along a segment 430 of the circumference of the top portion 106, or both. The food port opening 420 enables the insertion and removal of food while the cooking enclosure 100 is in place over the cooking surface.

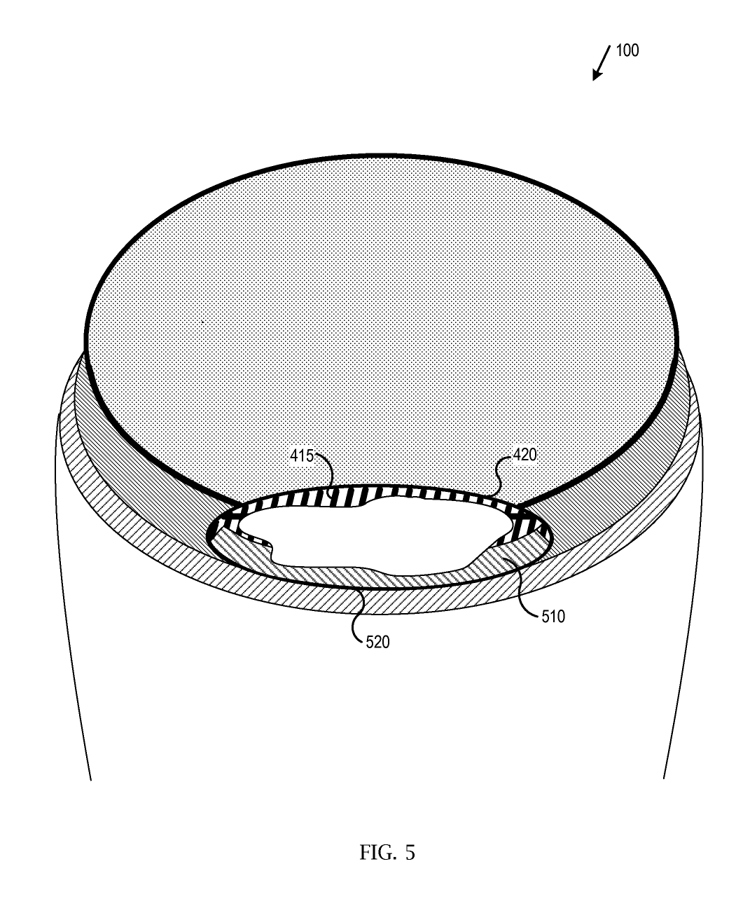

FIG. 5 is an upper-front perspective view of an insertable cooking enclosure 100 depicting a flame-retarding insert 510 according to various example embodiments. The flame-retarding insert 510 rests on the grilling surface 415 at the food port opening 420 and conforms generally to a shape of a lateral interior surface of the oven or outdoor grill along a periphery 520 of the grilling surface 415. The insert 510 serves to retard flames over an area of the grilling surface 415 that is unprotected by the baffle structures 128A, 128B (FIG. 1) at the food port opening 420. The unprotected area of the grilling surface 415 is hidden underneath the insert 510 and is thus not shown in FIG. 5.

Embodiments of the cooking enclosure 100 contemplated herein may be of various shapes and may include configurations for use with an outdoor barbecue grill, an oven, and/or a stovetop. The cooking enclosure 100 may be used over an existing baking plate 300. Alternatively the baking plate 300 may be built into the cooking enclosure 100 and/or may be insertable into the cooking enclosure 100. Likewise, the flame-retarding insert 510 may be integral to the cooking enclosure 100 or may be included as a separate component thereof.

The apparatus described herein may be useful in applications other than that of an insertable cooking enclosure. Examples of the cooking enclosure 100 are intended to provide a general understanding of the structures of various embodiments. They are not intended to serve as complete descriptions of all the elements and features of apparatus and systems that might make use of these structures. The various embodiments may be incorporated into existing barbecue grill, oven, and/or stove top designs.

Apparatus described herein convect heated air from a heat source, accumulate the heated air in a baking chamber within a cooking enclosure, and protect food in the baking chamber from excessively high temperatures associated with flames and/or hot spots. A more uniform cooking environment capable of producing more evenly-cooked food may result.

By way of illustration and not of limitation, the accompanying figures show specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense. The breadth of various embodiments is defined by the appended claims and the full range of equivalents to which such claims are entitled.

Such embodiments of the inventive subject matter may be referred to herein individually or collectively by the term “invention” merely for convenience and without intending to voluntarily limit this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments and other embodiments not specifically described herein may become apparent to those of skill in the art upon reviewing the above description.

The Abstract of the Disclosure is provided to comply with 37 C.F.R. §1.72(b) requiring an abstract that will allow the reader to quickly ascertain the nature of the technical disclosure. It is submitted with the understanding that it will not be used to interpret or limit the scope or meaning of the claims. In the preceding Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. A cooking enclosure, comprising:
a top portion to be oriented above and substantially parallel to a cooking surface when used for cooking;
at least one side portion formed along a periphery of the top portion and extending in a substantially orthogonal direction downward from the top portion, the top portion and the at least one side portion configured to form a food port opening along at least one of a lateral periphery of the cooking enclosure or a segment of the periphery of the top portion to allow for insertion and removal of food, the cooking enclosure to convect and accumulate heated air from a heat source; and
at least one lateral baffle structure affixed to the top portion or the side portion along an inner lateral periphery of the enclosure, spaced downward and away from the top portion, the lateral baffle structure to direct the heated air into a baking chamber bounded by the top portion, the lateral baffle structure, and the cooking surface and to retard flames and prevent extreme temperatures associated with flame edges and/or heating elements from reaching food located within the baking chamber while the cooking enclosure is located in place over the cooking surface.

2. The cooking enclosure of claim 1, the cooking surface comprising a baking plate.

3. The cooking enclosure of claim 1, the cooking surface configured with openings to allow the heated air to flow from the heat source up through the cooking surface, into a space between the side portions and the lateral baffle structure, and into the baking chamber.

4. The cooking enclosure of claim 1, the cooking surface configured with openings to allow the heated air to flow from the heat source up through the cooking surface and into the baking chamber.

5. The cooking enclosure of claim 1, the cooking surface integrated into the cooking enclosure via attachment to or insertion into at least one of the side portion or the lateral baffle structure.

6. The cooking enclosure of claim 1, the top portion substantially circular and the at least one side portion formed into a substantially cylindrical shape with an end circumference of the side portion abutted to the periphery of the top portion.

7. The cooking enclosure of claim 1, the top portion and the at least one side portion formed into a substantially continuous structure.

8. The cooking enclosure of claim 1, at least one of the top portion, the side portion, or the baffle structure comprised of at least one of metal, ceramic, thermal plastic, carbon fiber, or carbon nanostructures.

9. The cooking enclosure of claim 1, the baking chamber bounded by the lateral baffle structure, the top portion, and the cooking surface.

10. The cooking enclosure of claim 1, configured to fit into at least one of an oven or an outdoor grill.

11. The cooking enclosure of claim 1, the heat source comprising at least one of an outdoor grill, an oven, or a stove.

12. The cooking enclosure of claim 1, wherein the top portion is substantially flat or concave and is capable of receiving food for at least one of pre-baking, post-baking, or warming.

13. The cooking enclosure of claim 1, the top portion shaped as at least one of an oval or a polygon.

14. The cooking enclosure of claim 1, further comprising:
a footing edge associated with at least one of the side portion or the lateral baffle structure, the footing edge configured to conform to a perimeter of a baking plate and to rest on a surface substantially co-planar with a bottom surface of the baking plate.

15. The cooking enclosure of claim 14, wherein the surface substantially co-planar with the bottom surface of the baking plate is a grilling surface.

16. The cooking enclosure of claim 15, further comprising:
a flame-retarding insert to rest on the grilling surface at the food port opening and to conform to a shape of a lateral interior surface of the oven or outdoor grill along a periphery of the grilling surface, the flame-retarding insert to inhibit the flames from reaching food behind the food port opening through a space not covered by either the lateral baffle structure or the baking plate.

17. The cooking enclosure of claim 15, wherein the grilling surface is associated with an outdoor grill.

18. The cooking enclosure of claim 1, further comprising:
a footing edge associated with at least one of the side portion or the lateral baffle structure, the footing edge configured to rest on the baking plate.

19. The cooking enclosure of claim 1, the lateral baffle structure configured with a plurality of openings to provide a flow of hot air across the food in the baking chamber.

20. A cooking enclosure, comprising:
a substantially circular top portion to be oriented above and substantially parallel to a baking plate used as a cooking surface when cooking;
a side portion formed along a circumference of the top portion and extending in a substantially orthogonal direction downward from the top portion in a substantially cylindrical shape to form a lateral periphery of the cooking enclosure, the at least one side portion configured to form a food port opening along at least one of a lateral periphery of the cooking enclosure or a segment of the circumference of the top portion to allow for insertion and removal of food, the cooking enclosure to convect and accumulate heated air from an outdoor barbecue grill;
a lateral baffle structure affixed to the side portion along an inner lateral periphery of the cooking enclosure, spaced downward and away from the top portion, the lateral baffle structure to direct heated air into a baking chamber bounded by the top portion, the lateral baffle structure, and the baking plate and to retard flames and prevent extreme temperatures associated with flame edges from reaching food located within the baking chamber while the cooking enclosure is located in place over the baking plate; and
a flame-retarding insert to rest on a grilling surface at the food port opening and to conform to a shape of a lateral interior surface of the outdoor grill along a periphery of the grilling surface, the flame-retarding insert to inhibit the flames from reaching food behind the food port opening through a space not covered by either the baffle structure or the baking plate.
